(19) United States
(12) Patent Application Publication
(10) Pub. No.: US 2008/0252464 A1
(43) Pub. Date: Oct. 16, 2008

(54) Palatability monitoring system

(76) Inventor: Michael R. Panasevich, Susquehanna, PA (US)

Correspondence Address: MORGAN, LEWIS & BOCKIUS LLP, 1701 MARKET STREET, PHILADELPHIA, PA, 19103-2921, US

(21) Appl. No.: 12/072,545

(22) Filed: Feb. 26, 2008

Related U.S. Application Data
(60) Provisional application No. 60/923,468, filed on Apr. 13, 2007.

(51) Int. Cl. G08B 23/00

(52) U.S. Cl. 340/573.1

(57) ABSTRACT

A palatability monitoring system and method of use including at least one food monitoring station having at least one food container each with a reader and measurement device, a plurality of transponders readable by the reader, each transponder being associated with one of a plurality of animals; and a central station in communication with the at least one food monitoring station; where the at least one food monitoring station transmits event data to the central station to generate palatability information.

### RELATED APPLICATIONS

This application claims priority to U.S. Provisional Patent Application No. 60/923,468, filed Apr. 13, 2007, which is incorporated by reference in its entirety herein.

### BACKGROUND

An important component of pet food is palatability. Pet food manufacturers, along with ingredient suppliers, expend enormous amounts of time, energy, and money in pursuit of diets that will attract animals. Hundreds of animals are fed each day in order to observe and analyze their taste preferences.

### SUMMARY OF THE INVENTION

Among the various objects of one or more embodiments of the present invention are the following: to provide a system and method to achieve accurate palatability results for animals in a group-housed environment; to provide a system and method that takes into consideration the competition for food among group-housed animals; and to provide a system and method to automatically record food preference information during palatability testing whether palatability testing is in a group-housed or other environment.

According to some embodiments, a palatability monitoring system includes at least one food monitoring station, a plurality of identifiers each associated with one of a plurality of animals, and a central station in communication with the food monitoring station. In some embodiments a food monitoring station includes two food containers, where each food container is associated with a detector and a measurement device. In some embodiments, the identifier is readable by the detectors. In some embodiments, the food monitoring station is configured to transmit event data to the central station upon an occurrence of at least one of: i) at least one of the identifiers being in range of at least one of the detectors, or ii) a change in condition of at least one of the measurement devices. In some embodiments, the palatability monitoring system includes a database configured to record event data transmitted from the food monitoring stations.

In some embodiments, the event data includes at least one of: i) identification of the identifier proximate at least one of the detectors; ii) identification of the detector proximate at least one of the identifiers; iii) a condition of the measurement device associated with the first food container; iv) a condition of the measurement device associated with the second food container. In some embodiments, the feeding station is configured and dimensioned to transmit event data when an animal approaches the first food container and to transmit event data when an animal approaches the second food container.

In some embodiments, the food monitoring station includes an interior portion with access to the food containers and a barrier configured to substantially restrict access to the interior portion to a single animal. In some embodiments, the food monitoring station includes a substantially transparent wall configured to permit visual observation of a feeding event. In certain embodiments, the palatability monitoring system includes a camera configured to operate upon the occurrence of an animal entering the feeding station and/or approaching a food container.

In certain embodiments, the identifier includes a tag worn by an animal and the food monitoring station includes a beveled surface associated with detectors. In some embodiments, the beveled surface is configured and dimensioned such that the tag rests on the beveled surface in a position readable by one of the detectors when the animal approaches one of the food containers.

In some embodiments, a first measurement device is configured to measure the weight of food in the first food container and a second measurement device is configured to measure the weight of food in the second food container.

According to some embodiments, a method of collecting preference data from a plurality of group-housed animals includes providing a food monitoring station having at least two food containers that are accessible to one of the animals located in the food monitoring station, and transmitting event data from the food monitoring station to a central station when one of the plurality of animals approaches one of the at least two food containers. In some embodiments, transmitting event data includes transmitting information associated with the identity of the animal that approaches one of the at least two food containers. In some embodiments, transmitting event data includes transmitting consumption data associated with a change in condition associated with at least one of the food containers.

According to some embodiments, in a system having a food monitoring station including at least two food containers each of which are accessible to an animal located within the food monitoring station, and where each container is associated with a detector device and a measuring device, and the food monitoring station is configured to transmit data from the food monitoring station to a central station having a database for storing data, a method for generating palatability data includes transmitting animal identification information and container information from the monitoring station to the database in response to detection of the animal proximate one of the containers; and transmitting consumption information from the monitoring station to the database in response to a change in condition of the measuring device associated with one of the containers.

In some embodiments, transmitting animal identification information and container information includes transmitting information associated with a container the animal first approached. In certain embodiments, transmitting consumption information includes transmitting information associated with a reduction in food from one of the containers. In some embodiments, transmitting consumption information includes transmitting information only after a predetermined change in condition of one of the food containers is detected. In certain embodiments, monitoring information is continuously transmitted from the monitoring station to the central station.

According to some embodiments, a food monitoring station for use in a system for collecting palatability data from group-housed animals includes a plurality of walls defining an interior of the food monitoring station, a plurality of food containers within the interior of the food monitoring station wherein the food containers are equally accessible at least one of the group-housed animals located within the interior of the food monitoring station, a barrier configured to substantially restrict access to the interior of the food monitoring station to a single animal, a detector means for detecting an animal proximate one of the food containers, a change in condition means for detecting the consumption of food from one of the food containers, and a transmission means for transmitting data from the food monitoring station to a database. In some embodiments, the detecting means for detecting an animal proximate one of the food containers includes radio frequency identification.

### BRIEF DESCRIPTION OF THE DRAWINGS

FIG. 1 illustrates one embodiment of a palatability testing system of the present invention.

FIGS. 2A and 2B illustrates one embodiment of a food monitoring station of the present invention.

FIG. 3 illustrates a front isometric view of one embodiment of a food monitoring station of the present invention.

FIG. 4 illustrates a side view of one embodiment of a food monitoring station of the present invention.

FIG. 5 illustrates a back view of one embodiment of a food monitoring station of the present invention.

FIG. 6 illustrates a top view of one embodiment of a food monitoring station of the present invention.

FIG. 7 illustrates a cat consuming food from a food monitoring station of one embodiment of the present invention.

FIGS. 8A and 8B show exemplary screen shots of a user interface of one embodiment of the present invention for a program which may be used in a central station.

FIG. 9 shows an exemplary screen shot of a user interface for selecting preferences in one embodiment of the present invention.

FIG. 10 illustrates an exemplary screen shot of a database in one embodiment of the present invention.

FIG. 11 shows an exemplary flowchart for a procedure to start a user interface in one embodiment of the present invention.

FIG. 12 shows an exemplary flowchart for a procedure to activate a feeding station in one embodiment of the present invention.

FIG. 13 shows an exemplary flowchart for a procedure to process data in one embodiment of the present invention.

### DETAILED DESCRIPTION

Reference will now be made in detail to preferred embodiments of the present invention, examples of which are illustrated in the accompanying drawings. Wherever possible, the same reference numbers will be used throughout the drawings to refer to the same or like parts. To provide a thorough understanding of the present invention, numerous specific details of preferred embodiments are set forth including material types, dimensions, and procedures. Practitioners having ordinary skill in the art will understand that the embodiments of the invention may be practiced without many of these details. In other instances, well-known devices, methods, and processes have not been described in detail to avoid obscuring the invention.

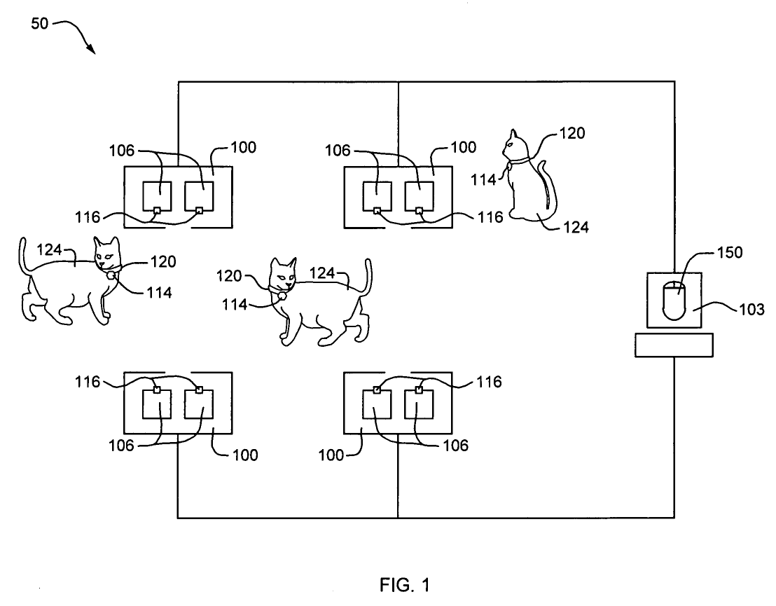

FIG. 1 illustrates one embodiment of palatability monitoring system 50. One embodiment of palatability monitoring system 50 is configured to identify how much and what food a particular animal is eating. Palatability monitoring system 50 is preferably used to generate palatability information within a group-housed animal environment. A group-housed environment is one in which a plurality of animals all have access to a plurality of food containers from which to choose. In one embodiment, it is desirable to determine palatability in group-housed environments to account for the impact of animal socialization on food consumption. Still, in other embodiments, palatability monitoring system 50 may be used to generate palatability information from an individually housed animal (i.e., an animal that is segregated from other animals).

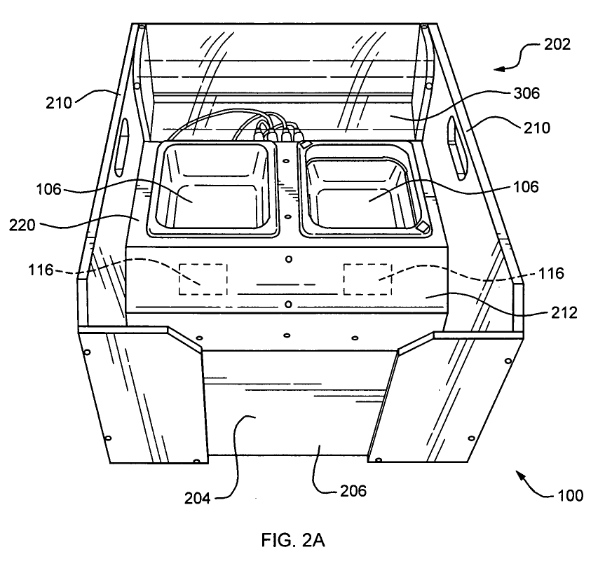

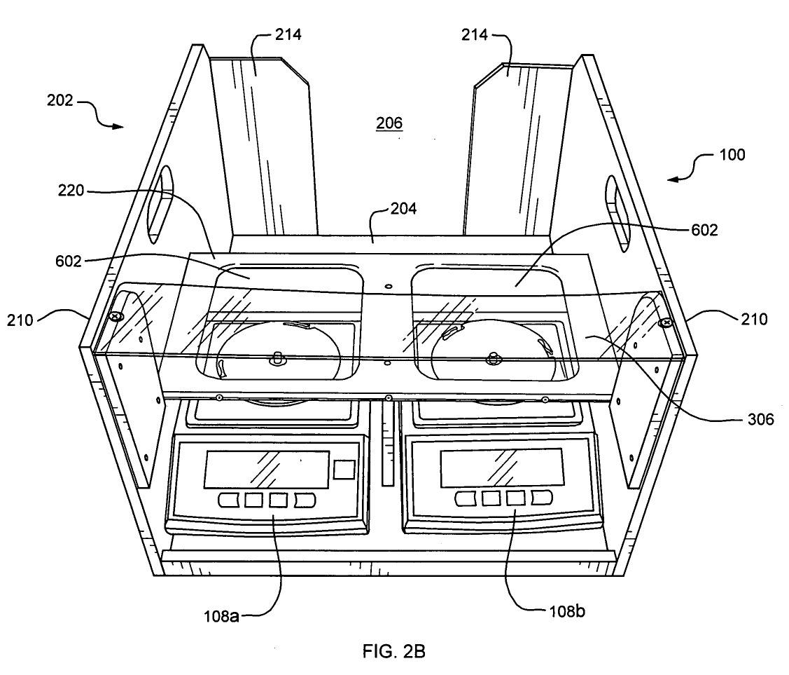

In one embodiment, palatability monitoring system 50 includes at least one food monitoring station 100 and at least one central station 103. In one embodiment, food monitoring stations 100 include at least one food container 106. In one embodiment, food monitoring stations include two food containers 106, a first food container 106a and a second food container 106b (see, for example, FIG. 2). In one embodiment, food monitoring station 100 can include more than two food containers 106 or a single food container 106.

In one embodiment, food containers 106 are associated with measurement devices 108. In one embodiment, each food container 106 is associated with a single measurement device 108. In a preferred embodiment, measurement device 108 is a scale and food container 106 rests on the scale within food monitoring station 100.

In one embodiment, food monitoring station includes at least one detector 116. In a preferred embodiment, each food monitoring station 100 includes a plurality of detectors 116. In one embodiment, each food container 106 is associated with at least one detector 116. In one embodiment, each food container is associated with a single detector 116. So for example, in the embodiment illustrated in FIG. 1, each food monitoring station 100 includes two food containers 106 each of which is associated with its own detector 116.

In one embodiment, palatability monitoring system 50 includes at least one identifier 114. In one embodiment, each identifier 114 is unique and is associated with a signal animal 124. In a preferred embodiment, identifier 114 is readable by detector 116.

Also illustrated in FIG. 1, central station 103 is in communication with each food monitoring station 100. Thus, in one embodiment, as animal 124 approaches any food container 106 in system 50, the detector 116 associated with that food container 106 detectors the identifier 114 associated with that particular animal 124 and information associated with that particular approach is transmitted from food monitoring station 100 to central station 103. That information, also referred to as event data may be transmitted to central station 103 upon the occurrence of any of a number of events. The events that may trigger that transmission of event data may include, among other things, the presence of a particular animal 124 proximate any of food containers 106 and a change in a condition of a food container 106 (e.g., a change in the quantity of food in at least one of food containers 106). Also, in one embodiment, the time (e.g., time of day) associated with the transmitted event data is recorded. In one embodiment, such as where an animal wears an identifier 114, event data is transmitted from food monitoring station 100 to central station 103 when an identifier 114 is in range (e.g., within a predetermined range) of at least one of the detectors 116. In one embodiment, event data is transmitted to central station 103 when there is a change in condition of the first measurement device 108a or the second measurement device 108b. In one embodiment, event data is transmitted to central station 103 upon the occurrence of one or more of the aforementioned events.

In a preferred embodiment, the event data that is transmitted is sufficient to identify the particular animal 124 that is proximate a particular food monitoring station 100, and proximate a particular food container 106 within that monitoring station 100. The event data may also be sufficient to identify the particular animal 124 that is consuming from a particular food container 106 within palatability monitoring system 50 and/or how much food the animal 124 consumed from the food container 106. Operation of palatability monitoring system 50 may therefore enable the collection of palatability data in a system housing animals 124 in a group environment with a plurality of food monitoring stations 100 each having a plurality of food containers 106 many or all of which contain a different type of food. Using the present system, it has been found that preference data can be collected that is substantially free of errors that may otherwise occur in different palatability systems that permit group-housed animals to select from a plurality of food types within a plurality of food monitoring stations. The present system may collect data such as number of meals per animal, frequency of eating, and length of meals. Embodiments of the present system allow for a true palatability test, i.e. by determining the palatability differences between two diets side-by-side in a monitoring system, and allows for greater efficiency in a group-housed environment by including the same two diets side-by-side in multiple monitoring stations in a the same system.

Components of the preferred embodiments of food monitoring system 50 will now be described in more detail.

Food Monitoring Station 100

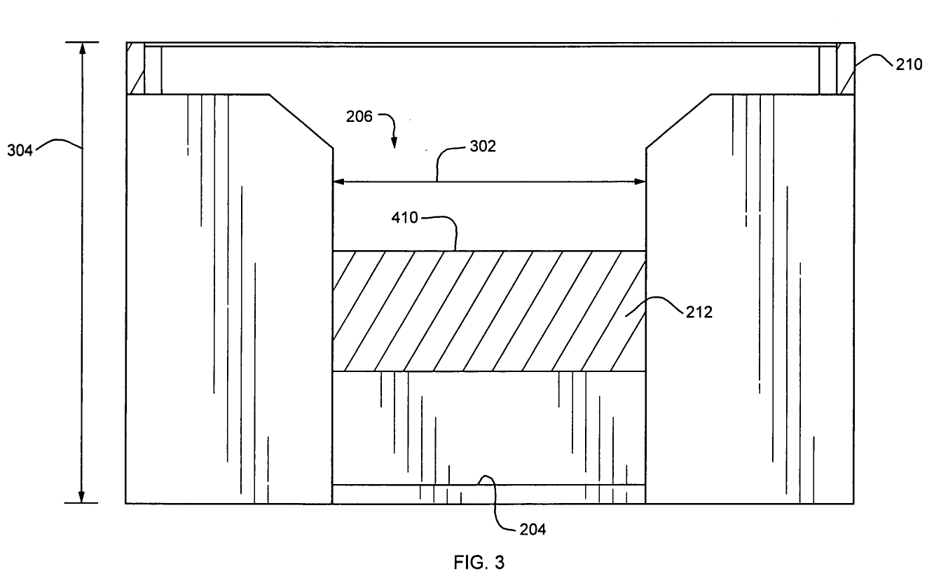

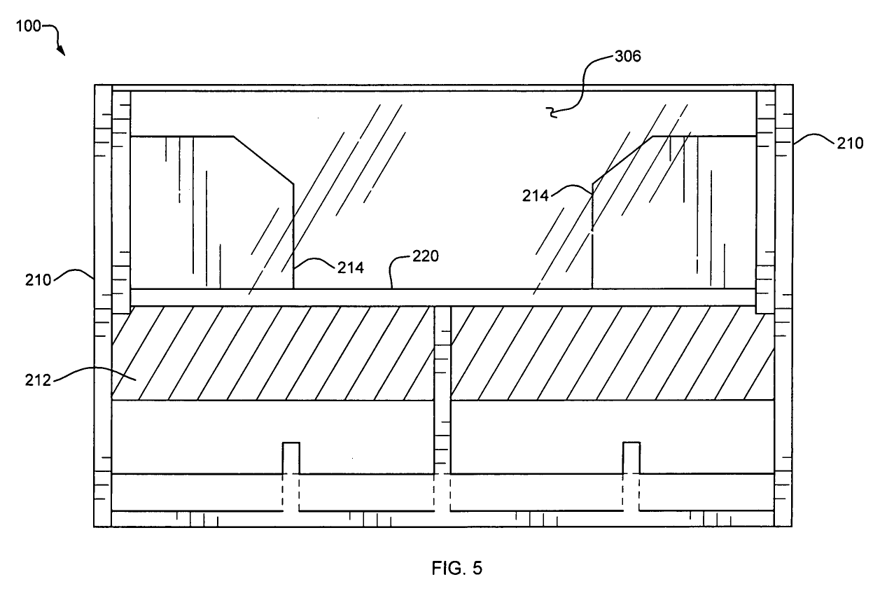

One embodiment of food monitoring station 100 is illustrated in FIGS. 2-7. Food monitoring station 100 includes two food containers 106 (shown empty). Food monitoring station 100 is configured to associate two detectors 116 proximate each of the two food containers 100 respectively. Food monitoring station 100 also includes housing 202. Housing 202 defines interior 204 of food monitoring station 100. In one embodiment, walls 210 form a barrier 214 that is configured to substantially restrict access to interior 204 to a single animal 124. In one embodiment, walls 210 define an entryway 206 where animal 124 may enter food monitoring station 100. Entryway 206 is preferably defined by housing 202. In one embodiment, entryway 206 is configured to restrict access to interior 204 to only a single animal at a time. In one embodiment, entryway 206 is configured to include a width 302 (FIG. 3) that is sized to permit the passage of a single mature animal (e.g., a cat). In one embodiment, entryway width 302 is dimensioned to be between about 15 cm (about 6 inches) and about 25 cm (about 10 inches), preferably about 18 cm (about 7 inches).

In one embodiment, housing 202 has walls 210 that terminate in an open top. In one embodiment, walls 210 have a height 304 of at least about 20 cm (about 8 inches). In one embodiment, wall height 304 is between about 20 cm (about 8 inches) and about 30 cm (about 12 inches), preferably about 26 cm (about 10.5 inches).

As illustrated in FIG. 2, interior 204 is configured such that when animal 124 is located in interior 204 it has access to all of the food containers within food monitoring station 100. In one embodiment, interior 204 is of a limited volume to discourage the presence of more than one animal 124. In other embodiments (not shown) food monitoring station is configured to permit the simultaneous feeding of multiple animals 124.

According to some embodiments, at least one wall 210 of food monitoring station 100 is configured to permit observation of interior 204 such that events such as feeding events can be observed and/or recorded. Observation wall 306 is preferably configured to allow visual observation of a feeding event. In one embodiment, observation wall 306 is transparent such a clear Plexiglas or acrylic material.

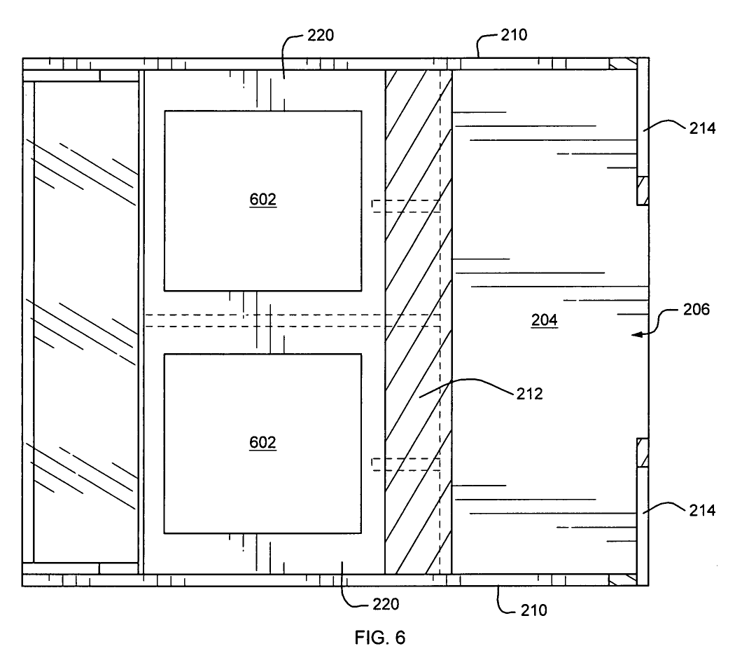

In one embodiment, food monitoring station 100 includes platform 220 that is configured to receive and/or align food containers 106 such that food containers 106 are positioned relative to measurement device 108 (e.g., positioned on a scale) and proximate to detectors 116. In one embodiment, platform 220 includes cut-out 602 (FIG. 6) through which food containers 106 may be placed. Platform 220 may also be positioned at a height sufficient to permit the protective storage during use of measurement device 108 (e.g., scales). Thus, as would be understood by those skilled in the art, in one embodiment, housing 122 is configured such that all sensitive equipment is inaccessible to animals 124 when in use.

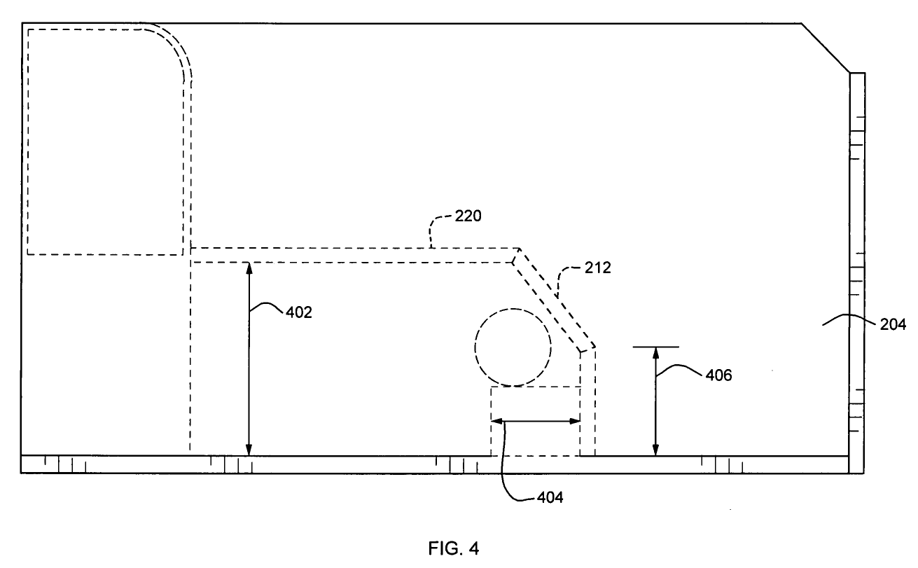

In one embodiment, platform 220 includes mantle 212. As perhaps illustrated best in FIGS. 2 and 4, mantle 212 is preferably configured with a beveled configuration relative to the top of platform 220. The beveled configuration is conducive to accepting a tag worn by animal 124 wherein the tag contains identifier 114 (e.g., an RFID tag). In one embodiment, an animal wearing a collar 120 with a tag leans in to eat or sniff food in food container 106. The tag dangles onto mantle 212 behind which is located detector 116. In one embodiment, the presence of the tag against mantle 212 is sufficient range for detector 116 to read identifier 114 included in the tag.

In one embodiment, platform 220 has a platform height 402 of between about 10 cm (about 4 inches) and about 15 cm (about 6 inches) and preferably about 11 cm (about 4 V₂ inches) above the bottom of food monitoring station 100. In one embodiment, mantle 212 extends from platform 220 toward entryway 206 a distance 404 (shown in FIG. 4) of about 5 cm (about 2 inches).

In some embodiments, food monitoring station 100 includes a camera. The camera may be a digital camera. The camera may be operably connected with detector 116. The camera may be configured to photograph animal 124 while animal 124 is proximate food monitoring station 100. In some embodiments, the camera is configured to operate upon the occurrence of animal 124 entering food monitoring station 100. In some embodiments, the camera is configured to operate upon the occurrence of animal 124 approaching a food container 106 and/or consuming food from food container 106. In some embodiments, the camera may photograph animal 124 in response to detector 116 recognizing a identifier worn by animal 124. In some embodiments, the camera may photograph animal 124 in response to detector 116 identifying the presence of animal 124. In some embodiments, food monitoring station 100 has a USB connection for interfacing a digital camera.

As described above, according to some embodiments, food monitoring station 100 includes a means for detecting the consumption of food from one of food containers 106. In one embodiment, the means for detecting the consumption of food from one of the food containers 106 includes measurement device 108. In some embodiments, food monitoring station 100 includes at least one measurement device 108. In one embodiment, each food container 106 is associated with a single measurement device 108. In some embodiments, measurement device 108 is configured to measure the weight of the food in associated food container 106. In some embodiments, measurement device 108 includes a scale. Measurement device 108 may be positioned under food container 106 to measure the weight of food container 106. In some embodiments, there is a first measurement device 108a that is configured to measure the weight of food in first food container 106a, and a second measurement device 108b that is configured to measure the weight of food in second food container 106b. In other embodiments, single measurement device 108 is associated with more than one food container. In one embodiment, food container 106 is set on measurement device 108 in food monitoring station 100.

As described in more detail below, measurement devices 108 may be configured to interface (e.g., by data output) with central station 103. In one embodiment, measuring device 108 includes a real-time USB output. In a preferred embodiment, measurement device includes a 1200 g×0.1 g scale having a sensitivity of 0.1 grams (about 0.0002 pounds) and a serial RS 232 communications port set with a stability time of 3 seconds.

Detectors 116 and Identifiers 114

In one embodiment, detectors 116, are configured and positioned to detect when animal 124 is located in the interior 204 of food monitoring station 100. In some embodiments, food monitoring station 100 includes a first food container 106a that is associated with a first detector 116a and a first measurement device 108a. Preferably, food monitoring station 100 also includes a second food container 106b that is associated with a second detector 116b and a second measurement device 108b.

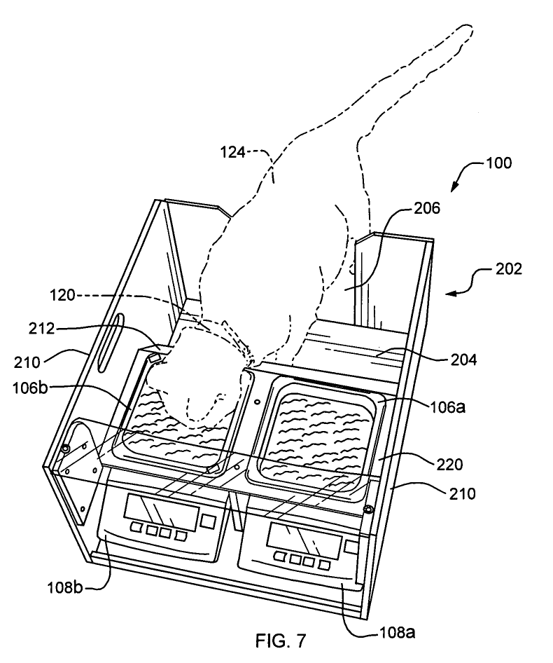

As shown in the embodiment illustrated in FIG. 7, when animal 124 enters food monitoring station 100 and approaches one of food containers 106, the animals collar 120 is positioned proximate mantle 112 behind which is located the detector 116 associated with the food container 106 and the measurement device 108. A tag dangling from collar 120 containing an identifier is brought into sufficient proximity with detector 116 to detect the presence of animal 124. Detectors may be positioned to detect the presence of animal 124 within food monitoring station 100 or at a particular food container 106.

In preferred embodiments, the detectors and or identifiers include radio frequency identification (“RFID”) detectors and transmitters. In one embodiment, animal 124 wears a break-away collar and an RFID tag based on the EM4102 protocol wherein each tag has a unique ID including ten characters (letter and/or numbers).

In one embodiment, detector 116 includes a USB controlled RFID reader having a range of 1 inch to 4 inches, a read rate that is adjustable up to 30 readings per second, a radio frequency of 125 Hz, returning data of a 40 bit unique ID contained in an EM4102 protocol tag. In one embodiment, the power consumed by detector 116 (5V, 100 mA) is supplied by measurement device 108.

Preferably, identifier 114 is detected by detector 116 only when animal 124 approaches food container 106 from the front of food monitoring station 100 and then only when animal 124 is within about four inches of detector 116. In a preferred embodiment, detector 116 scans for identifiers 114 (e.g., RFID tags) approximately 10 times per second.

In some embodiments, the detectors and identifiers include bar code scanners and bar codes. Other detectors and identifiers that achieve the purpose of this invention may be used as well. Regardless of the type of identifier or detector used, it is preferable that each animal in the group-housed environment be associated with a unique identifier and each food container 106 within the group-housed environment be associated with a unique detector 114. In some embodiments, a detector includes a laser system which triggers a camera upon detecting an animal.

Central Station 103

According to some embodiments, central station 103 is configured to communicate with at least one food monitoring station 100. Central station 103 may be located within or outside an animal housing area. In one embodiment, central station 103 includes a computer having minimum system requirements of 1 GHz, 512 MB RAM, USB 2.0, Microsoft Windows 2000 operating system with service pack 4 and Microsoft Excel software. Preferably, central station 103 is operated to collect, store and/or synthesize palatability information (e.g., event data) from the event data that is transmitted to central station 103 from one or more food monitoring stations 100. Palatability information may include, but is not limited to, identity of animal 124, identity of the food container 106 that animal 124 approaches first, frequency of approaches by one or more of the animals 124, duration of food consumption by one or more animals 124, amount of food consumed by one or more of the animals 124, frequency of food consumption by a particular animal, frequency that a particular food is consumed by group-housed animals, and rate of food consumption for a particular animal (e.g., during a consumption event, over the course of a predetermined period).

In some embodiments, central station 103 includes a database for storing information transmitted from food monitoring station 100. In some embodiments, central station 103 communicates with a remote database. In some embodiments, the system includes internet monitoring. To utilize internet monitoring, information may be stored in a database such as an SQL database in conjunction with or instead of a spreadsheet. In some embodiments, central station 103 includes software interface for data acquisition and analysis.

In some embodiments, when food monitoring station 100 is connected to central station 103, a user may program central station 103 to identify food monitoring station 100 and store pertinent information about station 100, such as location of the station, type of food contained in the station, and any other relevant parameters. When more than one food monitoring station 100 is connected to central station 103, data may be stored and organized for each individual food monitoring station 100.

Communication Hardware

According to some embodiments, food monitoring stations 100 and central station communicate wirelessly. In other embodiments, communication is hard wired.

In one embodiment, measurement device 108 communicates with central station 103 (e.g., a computer) by a serial RS232 connection through a serial to USB converter. In one embodiment, detectors 116 (e.g., an RFID reader) communicate with central station 103 through a universal serial bus connection. In one embodiment, the serial to USB converter and detector 116 are connected to a USB hub (e.g., a 4 port USB hub). In one embodiment, the USB hub is connected to a USB port in central station 103 or to another hub depending on the number of components in the system. In this manner, system 50 may be expanded to include any number of food monitoring stations 100 or central stations 103. In a preferred embodiment, palatability monitoring system monitors up to about 40 food monitoring stations per central station 103

In one embodiment, a USB controller is capable of handling up to 127 USB devices. Each USB to serial converter may be considered one device, as well as each RFID reader, and each USB hub. Therefore in one embodiment, each food monitoring station uses four USB devices. In some embodiments, more than one USB controller is installed in a computer.

Operation of Palatability Monitoring System 50

Some embodiments of the operation of palatability monitoring system 50 will now be described. According to some embodiments, palatability monitoring system 50 generates, stores and analyzes palatability data that is collected from one or more food monitoring stations 100 and transmitted to central station 103. The event data is preferably analyzed at central station 103 to synthesize palatability information.

Transmitting Event Data

In some embodiments, event data that is transmitted from food monitoring station 100 to central station 103 includes but is not limited to animal identification information and food container information. In one embodiment, event data includes detection of animal 124 at food monitoring station 100, detection of animal 124 at food container 106, identity of food monitoring station 100, identity of food container 106, identity of animal 124 at food monitoring station 100, identity of animal 124 at food container 106, weight of food in food container 106 before animal 124 begins to eat, weight of food in food container 106 when animal 124 stops eating, time when animal 124 begins to eat, time when animal 124 stops eating, time when animal 124 approaches food monitoring station 100, time when animal 124 approaches food container 106, time when animal 124 leaves food monitoring station 100, and time when animal 124 leaves food container 106.

In some embodiments, event data is transmitted from palatability monitoring station 100 to database 150 in the central station 103 in response to a detection of animal 124 proximate one of the food containers 100. In some embodiments, each detection of identifier 114 by a detector 116 is an event that generates event data.

In some embodiments, event data is transmitted when detector 116 detects an identifier 114 to be within about 0 inches to about 5 inches. In some embodiments, animal identification information is transmitted when detector 116 detects an identifier 114 to be within about 0 inches to about 3 inches. In one embodiment, event data is also transmitted from food monitoring station 100 to database 150 in response to a change in condition of the measuring device 108 associated with one of the food containers 106.

So, for example, when animal 124 wearing identifier 114 approaches within a predetermined distance of detector 116, event data is transmitted to central station 103, is optionally displayed on a user interface (described in more detail below) and written to database 150 (e.g., including a spreadsheet) also described in more detail below. Preferably, each time a detector 116 identifies a new identifier 114, the identity of the new identifier 114 is recorded in database 150. In one embodiment, as long as animal 124 remains proximate to detector 116, the identity of the identifier 114 will be recorded at database 150 as being associated with that particular detector 116 (e.g., as the detector cycles through detection modes with the identifier within range). If the location of identifier 114 changes (e.g., when animal 124 moves) the change is recorded when a different detector 116 identifies identifier 114, or when the identifier 114 returns to the first detector 116 after being out of range for one detection cycle.

In one embodiment, event data is also transmitted from food monitoring station 100 to central station 103 when a condition at the food container 106 changes. For example, when animal 124 begins consuming food from a particular food container 106 and when the condition of the food container 106 stabilizes (e.g., when there has been a weight change of at least three grams for a predetermined period of time, such as for example three seconds). In one embodiment, event data is transmitted whenever the weight of food container 106 changes by at least a predetermined weight (e.g., about three grams). In a preferred embodiment, recording changes in food container condition that are caused by animals jumping or bumping into the feeding stations are not recorded (or at least reduced) because of this predetermined weight change threshold established by the operator of palatability monitoring system 50.

Consumption Data

In some embodiments, food monitoring station 100 transmits consumption information to the database of central station 103 in response to a change in condition of the measuring device associated with at least one of the food containers in food monitoring station 100. In some embodiments, transmitting consumption information includes transmitting information associated with a reduction in food from at least one of the containers. In certain embodiments, consumption information is transmitted only after a predetermined change in a condition of one of food containers 106 is detected. In some embodiments, consumption information is transmitted after a change in weight in food container 106 of about 3 grams (about 0.007 pounds).

Timing of Monitoring

In some embodiments, monitoring information is continuously transmitted from the monitoring station to central station 103. In other embodiments, monitoring information is transmitted from food monitoring station 100 only upon detection of event data by food monitoring station 100. In some embodiments, food monitoring station 100 checks for event data at predetermined time intervals. In some embodiments, detector 116 scans for a proximate transponder at predetermined time intervals. In some embodiments, detector 116 scans for a proximate identifier 114 (e.g., a transponder) between about 10 times per second to about 30 times per second. Detectors 116 which are in close proximity may be cycled on and off, such that one detector 116 is on while the other is off, to eliminate interference from each other. In some embodiments, proximate detectors 116 are cycled in 100 millisecond intervals. In some embodiments, a measurement device 108 checks for a change in condition at predetermined time intervals. In other embodiments, measurement device 108 continuously checks for a change in condition.

Receiving and Analyzing Data at a Central Station

In some embodiments, central station 103 includes software to allow user interface and to organize the event data and present the palatability information. In some embodiments, once food monitoring station 100 and central station 103 are connected and properly programmed, selected foods may be placed in food monitoring station 100. Monitoring may then be initiated. According to some embodiments as described herein, each time food monitoring station 100 detects that animal 124 approaches and/or eats from food monitoring station 100, the event data is transmitted to central station 103. In some embodiments, central station 103 receives, stores, analyzes, and tabulates data from food monitoring station 100. Palatability information may include, but is not limited to: which container 106 animal 124 approaches first, which container 106 animal 124 eats from first, frequency of approaches, duration of food consumption, amount of food consumed, frequency of food consumption, rate of food consumption, and number of times animal 124 goes from one food container 106 to another.

User Interface Program Examples

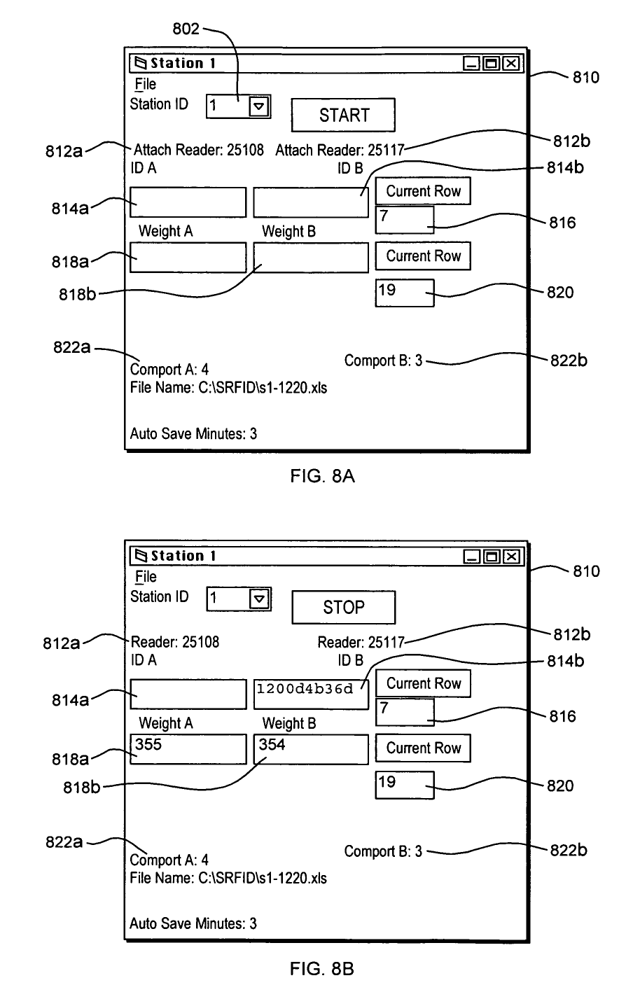

FIGS. 8A and 8B illustrate an exemplary station interface 810 for one food monitoring station 100; in this instance the food monitoring station 100 designated in the header as Station 1. Station interface 810 displays the unique reader identification number 812 for detectors 116 associated with the food monitoring station selected in station selection field 802 (in this instance Station 1). In one embodiment, the parameters for any station can be viewed by selecting the particular station from station selection field 802 which is preferably a drop down menu.

As can be seen from the figures, Station 1 is associated with two unique detectors 116 (referred to in the figures as readers) each having a unique number. The two unique detectors 116 are each respectively associated with a unique food container 106 in this two bowl food monitoring station. As illustrated, the reader associated with Bowl A has a reader identification number 812a (e.g., a detector serial number) of 25108 and the reader associated with Bowl B having an reader identification number 812b of 25117. The message “Attach Reader: Serial Number” (as shown in FIG. 8A) indicates that the requested detector is not attached. The message “Reader: Serial Number “(as shown in FIG. 8B) indicates that the detector 116 has been attached.

Also illustrated in FIGS. 8A and 8B, station interface 810 includes an ID Bowl field 814 (814a is the field for first food container, Bowl A and 814b is the field for second food container, Bowl B). ID Bowl field 814 displays the identity of the identifier 114 that was last read by detector 116 associated with a particular food container 106. Thus, if an identifier 114 is within range of detector 116, such as less than 4 inches (10 cm), a unique code associated with the identifier is displayed in the field. Preferably, the identifier code remains in the field until either a new identifier 114 is read, or until the identifier is read by the second detector. If, for example, no identifier is within range of detector 25108, ID Bowl field 814a will be blank.

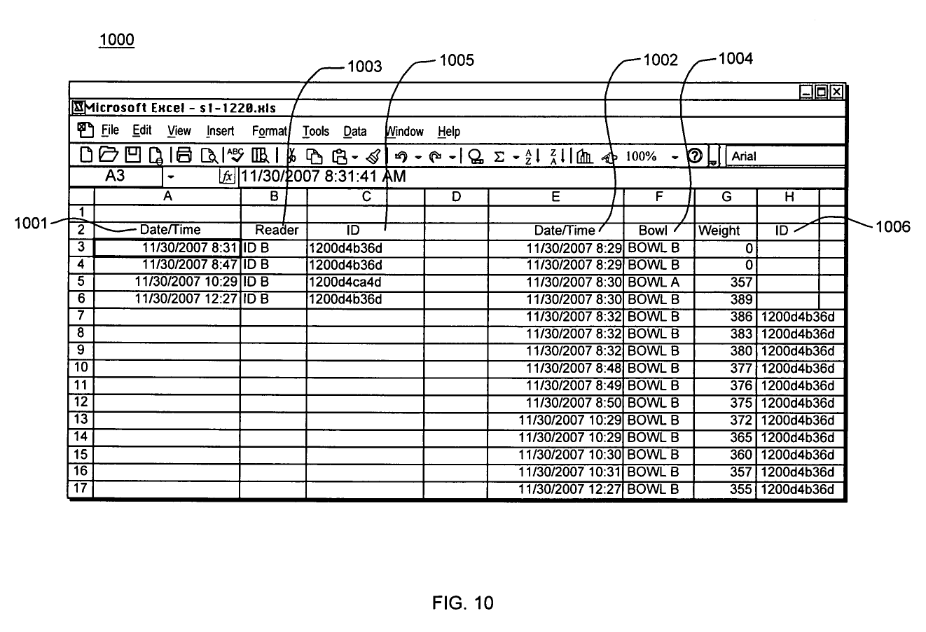

Current row field 816 indicates the row that data will be written to database 150 (e.g., spreadsheet 1000 illustrated in FIG. 10). Current row field 816 can be changed by the operator to affect the placement of data in database 150.

Also shown in FIGS. 8A and 8B, weight field 818a and 818b display the last reading transmitted from the respective measurement device 108. In some embodiments, the measured value (e.g., a weight reading) will update when the change in value is received from the measurement device 108 is greater than a predetermined amount (e.g., 3 grams). Setting a predetermined amount may help to reduce values being entered into database 150 that may occur from food monitoring station 100 being bumped, jumped on and etc.

Current weight row fields 820a and 820b, illustrated in FIGS. 8A and 8B indicate the next row that will be written to in database 150. The database row may be changed and a new row may be entered into the field by clicking the Weight Current Row button, for instance to correct a misreading by detector 116 or measurement device 108.

Comport identifier fields 822a and 822b indicate the communications port that is associated with the food monitoring station 100 (e.g., Station 1) that is being viewed on station interface 810. The field labeled “File Name” indicates the name and location of database 150 (see, e.g., FIG. 10) for the food monitoring station being viewed. The field labeled “Auto Save Minutes” indicates the time remaining, in minutes, before the next Auto save of the spread sheet. This starts counting down when the start button is clicked.

In the embodiment of FIGS. 8A and 8B, the “Start” and “Stop” button controls the collection of event data. The button initializes the data collection if clicked when “Start” is displayed. When the button is clicked, the program checks for the presence of an active database 150. If the database exists it is opened, and if it is already open, the program begins to use the database. If the database cannot be open, that is if it is in use by another computer, an error will be displayed and the data collection will not be started. If database 150 can be used then the communication ports are open and detectors 116 are set to start collecting data. If “Stop” is displayed on the button, then clicking may close the communication ports and stop detector 116 collecting, and the spread sheet is then saved.

Exemplary User Interface Program

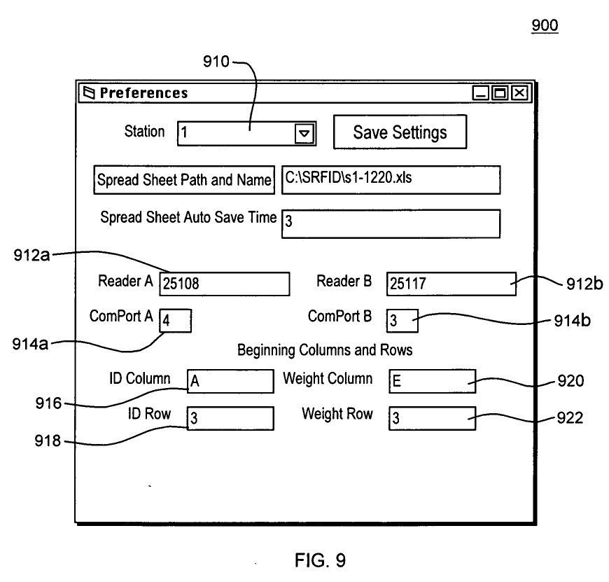

FIG. 9 illustrates one embodiment of a preferences interface 900. Preference interface 900 may be used to change user interface options. For example, a user may use station pull-down menu 910 to select the food monitoring station 100 for which the preferences are being displayed. Any changes are saved by clicking the Save Changes button. In some embodiments, if the station is changed a prompt to save changes will be displayed. Database pathway field 920 may be used to display the selected location of database 150 (e.g., an Excel spreadsheet such as in FIG. 10). As shown in FIG. 9, the field labeled “Spread Sheet Auto Save Time” indicates the time, in minutes, until the spread sheet will be saved automatically.

To change preferences, a user changes the values in the fields shown in FIG. 9. Referring to FIG. 9, reader fields 912a and 912b indicate the identity of detector 116 associated with a particular food container 106. As indicated in FIG. 9, Station 1, is a two bowl system having an identity of first detector 116 of 25108 that is associated with a first food container 106 and an identity of a second detector 116 of 25117 that is associated with a second food container 106. Comport fields 914a and 914b indicate the communication ports designated for each the two food containers 100. In this instance comport 4 is associated with detector 25108 and comport 3 is associated with reader 25117. In some embodiments, a dual serial RS232 db9 to USB converter is used for the communications port at each station. The RS232 db9 adapter may be used to connect to the measurement device 108 (e.g., a scale). The USB converter's port numbers may be configured with Microsoft Windows device manager.

A user may also change the preferences for writing data to database 150 (e.g., a spreadsheet) by changing the values in the appropriate interface fields. As shown in FIG. 9, the ID Column field 916, weight column field 920, ID row field 918 and weight row field 922 indicate the beginning location in database 150 to which data will be written during an event data communications event.

For example, ID Column field 916, weight column field 920, ID row field 918 and weight row field 922 may indicate the beginning fields for data that populated into spreadsheet 1000 (FIG. 10) during an event data communications event. For example, FIG. 9 illustrates that animal identification data will be first written to column B row 3 of spreadsheet 1000. As illustrated in FIG. 10, in one embodiment, three fields (e.g., time, detector ID and food container ID) are written to the specified location for ID data.

FIG. 9 further illustrates that weight data collected at station 1 will be first written to column F, row 3 of spreadsheet 1000. As illustrated in FIG. 10, in one embodiment, three fields (e.g., time, weight and food container ID) are written to the specified location for weight data.

In some embodiments, the column must be one or two letters that are used in the spread sheets. If the columns overlap for the ID and the weight data, an error is displayed when a save is attempted. In the embodiment of FIG. 9, ID row field 918 and weight row field control the starting database location (e.g., the spreadsheet row) for all the detectors 116 associated with the food monitoring station for which the preferences are being edited.

In some embodiments, a “Save Button” appears if any changes to preferences are made. If the station is changed or the preferences window is closed, a pop up message will appear. If the Save button is clicked and no other changes are made, the save message will not be displayed. In some embodiments, a “Save Setting Changes?” prompt appears if changes are made and the user tries to close preferences window without saving or the user tries to change to a new station without saving first.

Launching a User Interface Program

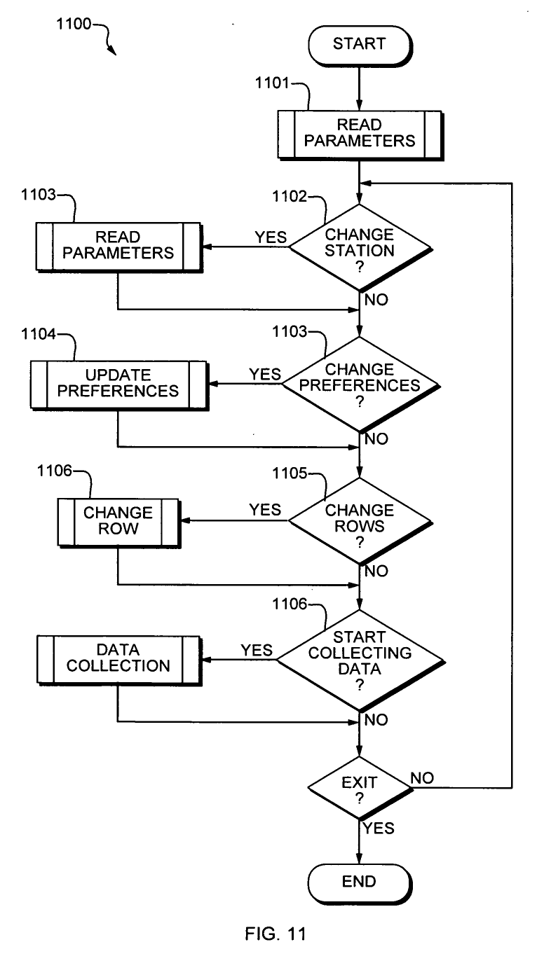

FIG. 11 illustrates one embodiment of executable routine 1100 when a user interface program is launched. Referring to FIG. 11, upon launching the user interface, the parameters for the default food monitoring station (e.g., station 1) are read at step 1101. The program reads the parameters from a file (e.g., an .ini file) preferably located in the same directory as the executable file. The readable file may contain information including the number of food monitoring stations 100 available, the communications ports associated with each food monitoring station 100 (e.g., the identity of both communications ports in a two bowl station), the identity (e.g., the RFID serial number) of all detectors 116 for each food monitoring station 100, the automatic save timing information for saving data in database 150 (which may be independent of the save information stored in the database), the rows to start writing data into database 150 for both condition change (e.g., weight) information and identification information (e.g., the information associated with identity of each food container 106, each detector 116, and animal 124). In one embodiment, if data collection stops, the current row information is preferably written to the .ini file to be used when data collection is restarted. The .ini file also includes the columns to start writing such data to database 150. Preferably the column does not change during data collection. The .ini file preferably also includes the next row number into which data is written at database 150 which changes in increments of 1 row after each data is written to a previous row. The .ini file also preferably includes the name and location of the data file used by each station 100.

If a new station is selected at step 1102 (e.g., via drop down menu such as station selection field 802 illustrated in FIGS. 8A, 8B) then the parameters (e.g., as stored in an .ini file such as those described above) for that food monitoring station are read at step 1103. Otherwise, the routine looks for preference changes of the selected station at step 1103. If those stations' preferences have been updated, the updated preferences are read at step 1104. At step 1105, routine 1100 looks for any changes to the database location to start writing data, if the rows have been changed, they are updated in step 1106. At step 1106, the user is prompted to either start collecting data or exit routine 1100.

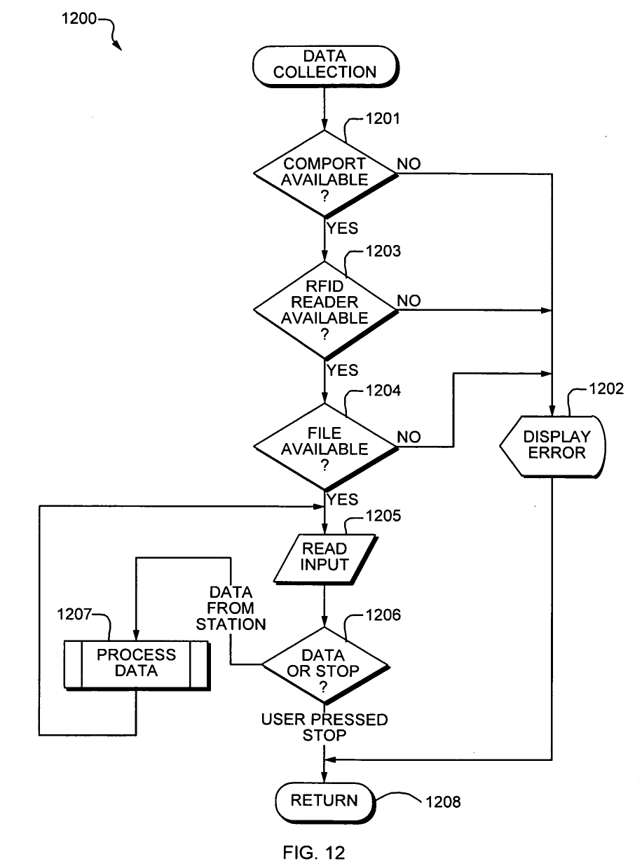

Routine 1200, illustrated in FIG. 12, is an exemplary routine that operates to activate a feeding station data collection once a user clicks the “Start” button on the user interface. The program first checks whether the communication ports connected to the measurement are valid at step 1201. If they are not, an error message will be displayed at step 1202. If the ports are valid, the program checks if the station has available detectors 116 at step 1203. If not, an error message will be displayed at step 1202. The program then checks if the parameter file is available at step 1204. If not, an error message will be displayed at step 1202. The program will read data from the food monitoring station 100 at step 1205 by first determining whether the input is data or a Stop signal from the user at step 1206. If the input is data, the program will process the data at step 1207 and again read input at step 1205. If the input is a Stop signal, the program will stop reading input at step 1208.

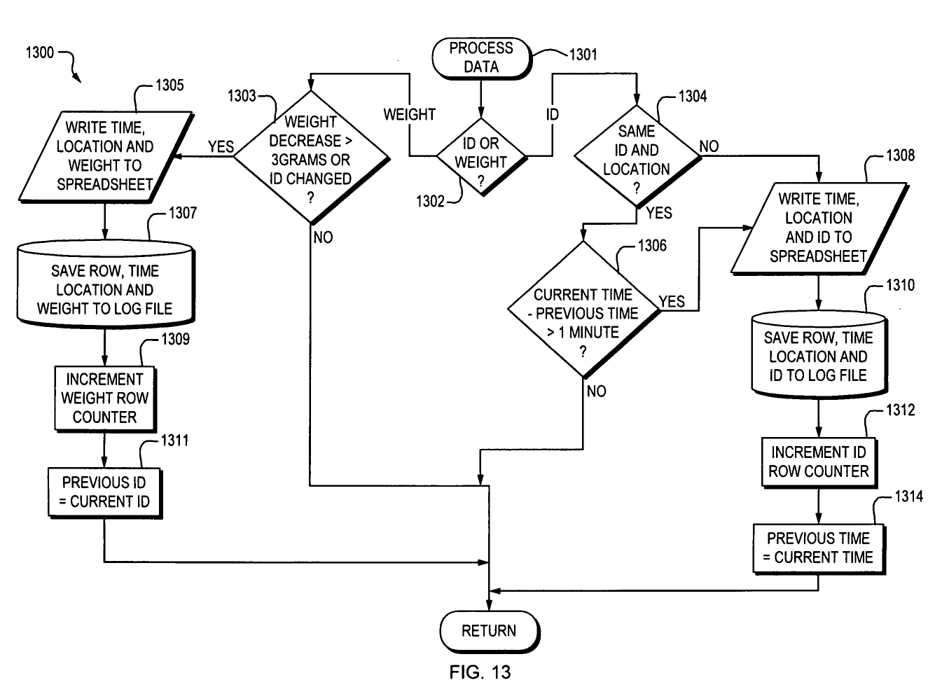

Routine 1300, illustrated in FIG. 13, is an exemplary routine that operates to determine the type of data generated from palatability monitoring system 50 and how to process the data. Data processing is initiated at step 1301 when data is received at central station 103. At step 1302, the type of data is identified. For example, data type may be data associated with a change in condition. In the example of FIG. 13, the change in condition information may be weight data (e.g., the weight of food containers 106). The data may also be identification data. Identification data may include detector information (e.g., serial number of detector 116), animal information (e.g., the identity of animal 124 or identity of identifier 114 such as an RFID tag serial number) and/or food container information (e.g., the identity of the food container 106, the identify of the food in the food container 106).

If the data type is change in condition information, step 1303 operates to determine whether the change in condition meets a predetermined parameter. In this instance the predetermined parameter is a weight decrease of at least 3 grams or a change in ID. When a new ID is introduced, current weight is recorded even when a weight decrease is not greater than 3 grams. If the change in condition parameter is not satisfied routine 1300 ends and the data is not recorded in database 150. If the change in condition parameter is satisfied data is recorded in database 150. The recorded data may include the time the event data was sent, the location of the condition change (e.g., the identity of food container 106 that has experienced a change in weight in excess of 3 grams), and the condition data (e.g., the new weight of the food container 106 that experienced the change in weight). Referring to step 1305 in FIG. 13, the data is preferably written to a spread sheet starting at a predetermined row and column such as that illustrated in FIG. 10 (e.g., in FIG. 10, time data is first written to time field 1002, location data is first written to location field 1004 and condition data is first written to condition field 1006). Once data is written to the file, the data is saved at step 1307 and the row counter is set at step 1309 to write the next received data on the next row in database 150. Referring to step 1311, the ID is stored for comparison with the next incoming ID information.

If the data type received at step 1302 is identification data, a determination is made at step 1304 whether the identification data received is the same identification data previously received or is different. For example, a determination as to whether this data reflects same animal 124 at the same food container 106 as the previous data. If those conditions are the same, and lapsed time is not greater than a predetermined parameter (e.g., not greater than 1 minute as illustrated in step 1306, then the data is not recorded. If, however, the predetermined lapsed time condition is satisfied, data is written to database 150 at step 1308. In the embodiment illustrated in FIG. 13, the data written in this instance is time data, location data and ID data. By way of further example, as illustrated in FIG. 10, the data written to spreadsheet 1000 at step 1308 may be time data written to ID time field 1001, the identity of location data may be written to ID location field 1003 (e.g., the identity of a particular detector associated with a particular bowl) and the identity of animal 124 at a particular bowl may be written to ID field 1005.

Referring again to step 1304, if the ID and location data are not the same, the data is again recorded at 1308 as described above. After ID data is recorded, the data is saved at step 1310 and the row counter is incremented at step 1312 so that the next ID data received is save to a different row in database 150. Referring to step 1314, the time of receipt of the ID data is stored, so that the elapsed time may be calculated upon receipt of the next ID data.

In certain embodiments, the identification information will be written to the spreadsheet once per minute as long as the same detector 116 continues to detect an identifier 114. The same identification information may be written to database 150 more often than once per minute if the location of identifier 114 changes and/or returns.

Referring back to FIG. 10, in preferred embodiments, each time event data is written to the spreadsheet 1000, a time stamp and the food container location (A or B for a two-bowl system) is also written with the corresponding data. The identification information and the weight information may be written in two separate sets of three columns each in spread sheet 1000. In some embodiments, the data is analyzed using the time stamp and location correlation to organize palatability information from the event data. In some embodiments, each food monitoring station has its data recorded on an individual spreadsheet.

In some embodiments, photographs are taken from the food monitoring station 100 each time animal 124 enters food monitoring station 100. If condition change data is tabulated without corresponding identifier data, the digital picture may be reviewed after data collection in order to differentiate which animal ate without being scanned. The camera can also be used as a method of validating the system and the software.

The following embodiments are exemplary and do not limit a monitoring system of the present invention.

### EXAMPLE 1

### Food Monitoring Stations

A two bowl palatability testing food monitoring station in a group housing environment will be described.

The housing 202 for each food monitoring station 100 is constructed from smooth ½″ white plastic, high density natural plate products produced by Quadrant Engineering Plastic Products.

Bowl cutouts 602a and 602 are cut into the platform 220, large enough not to impede upon bowl weighing.

Each bowl 106a and 106b sits on separate scale 108a and 108b. Scales 108a and 108b may be Citizen, Model Number 1200 scales. Station 100 has been developed to utilize different types of scales. For example a Citizens MN 1200 may be used for cats and a Citizens MN 2100 may be used for dogs. The model 1200 scales have a range up to 1200 grams and the model 2100 will measure up to 3000 grams.

The sides of the housing are constructed 10 inches high with a 7 inch entry way 110. The size of the entry way door 110 is reduced from the total width in order to help prevent multiple animals 124 from entering station 100. Each animal 124 is equipped with an RFID 125 kHz, EM 4102 Protocol tag 114 by Trossen Robotics, part number—RFID-TAG-125-DSK30. The mantle 112 in front of each bowl 106a and b is angled such that the animal's RFID tag 114 will dangle over it when eating.

Mounted on the under side of the angled plastic mantle 212 are two USB RFID readers 116 manufactured by Trossen Robotics, part number—RFID-RDR-P1023. Readers 116 are mounted underneath and in front of each bowl 106a and b.

Clear Plexiglass Acrylic, manufactured by Arkema, Inc., is used in the back of station 100 in order to keep animals 124 from accessing the scale compartment and to have a view of entry way 110 from the back, for digital picture snapshots.

FIG. 7 illustrates palatability monitoring system 50 in use with cat 124 approaching and eating the food in the food monitoring station 100.

### EXAMPLE 2

### Component Connections and Interfacing

A “Dual Serial to USB Converter” manufactured by Cable Unlimited, part number-USB-2925, is used to combine the serial outputs of both scales to one USB.

Each RFID reader is interfaced with a USB port. A 4 port USB hub, manufactured by Cables Unlimited, part number—ATN-G-uh174, is used to combine the scales USB, plus the two reader USB, into one USB output to the Palatability Central Station.

An extra USB port is available at each station for the optional digital camera or web camera.

Output from each food monitoring station is cabled to the central station via a single USB cable. USB extension cables may be used for long distances.

### EXAMPLE 3

### Central Station 103

The central station has minimum system requirements of 512 MB RAM, Pentium III 800 MHz CPU, Microsoft Windows 2000/XP, and Microsoft Excel, USB 2.0.

Central station 103 is capable of interfacing up to 40 two-bowl food monitoring stations equipped for group housing data acquisition. The maximum number of other type stations depends upon what configuration is being used. The maximum number of stations is based on the limited number of corn ports and USB connections available at the computer and the memory usage and speed requirements of opening multiple interface windows and Excel windows for each station.

USB hubs of different configuration are used to combine multiple food monitoring stations to the palatability central station.

User interface software was developed in Visual Basic that initializes each station and allows the operator to choose what type of station is being used along with the RFID reader identification number.

Real time central station data consist of the actual Excel log for each food monitoring station. Data includes the cat ID when a bowl is approached plus the time of the event, the weight of each bowl after a meal plus the time of the event. Data analysis at the central station consists of online graphical presentation of cat data and food monitoring station data. FIG. 13 represents a flow chart for how data is analyzed once it is received at a central station. Statistics may be calculated and analyzed on the following parameters:

a. individual cat consumption of each type of food

b. frequency of eating for each cat. Frequency of eating may describe how many times an animal enters a food monitoring station and consumes food during a predetermined period of time, such as one day.

c. input ratio per meal (calculated by taking the total consumed of a first food, minus the total consumed of a second food, divided by the total amount consumed of both foods)

d. first type of food approached at each meal. A meal may be defined as an event including an animal approach, consumption of food, and subsequent retreat from the food monitoring station.

e. first type of food eaten at each meal

f. total feeding time for each type of food (indicative of ferocity of eating)

g. total number of back and forth events per cat. A back and forth event includes the occurrence of an animal approaching and/or consuming one type of food, and then switching to approach and/or consume a second type of food. Such an event may also include the animal subsequently returning to approach and/or consume the first type of food.

h. summary data of collect group of cats parameters. Such summary data may include data compiled for multiple animals in group housing, such as the identification of each animal in the group housing, the count of meals per animal, the total quantity of food consumed per animal, the number of approaches per food container, the number of first consumed per food container, the total quantity of food consumed per food container, the average meal time, and the average amount consumed per meal. Additionally, this data may be combined to show the overall totals for all animals in the group.

### EXAMPLE 4

### Data Capture

The data capture program is written in Visual Basic 6. The program can send and receive information through two communication ports and two USB RFID ports. The communication ports are USB ports converted to communication ports using the MosChip Semiconductor Technology driver version 1.8.5.11. The detectors include RFID readers which use the Phidget 21 DLL version 2.1.2 and the Phidget COM Library version 2.1.1 provided by Trossen Robotics.

When an identifier containing an RFID transponder worn by an animal is within range of the RFID detector (e.g., 0 in. to 4 in.), the detector transmits the identifier information to the program. The program will then analyze the identifier information to determine whether to record the information to the Excel spreadsheet. If the program determines that the identifier information should be recorded, the program prints the time, the detector location, the food container, and the identifier that was read to an Excel spreadsheet or to a text file. In order for the program to print to the Excel file, the Excel file must be open and in read/write mode.

When the weight of a bowl changes, data is transmitted to the program. The time, bowl location, type of food, and the weight value transmitted to the program are printed to the next line in the Excel spreadsheet. The current row numbers for the identifier and the weights are stored in an INI file after each row is printed. The INI file also stores the settings for each station, including communication ports, RFID serial numbers, spreadsheet column and rows for weight information and identifier information, and the spreadsheet name. If the program is terminated the INI file will have the current location in the spreadsheet to resume capture and print the data to the next row. The data may be analyzed in Excel once it is printed to the spreadsheet.

Although the foregoing description is directed to the preferred embodiments of the invention, it is noted that other variations and modifications in the details, materials, steps and arrangement of parts, which have been herein described and illustrated in order to explain the nature of the preferred embodiment of the invention, will be apparent to those skilled in the art, and may be made without departing from the spirit or scope of the invention. Any dimensions referenced herein are preferred approximate dimensions. Those skilled in the art will recognize that any dimensions selected to achieve the objectives of the present invention are within the scope thereof.

I claim:

1. A palatability monitoring system comprising:
at least one food monitoring station having:
a. a first food container associated with a first detector and a first measurement device;
b. a second food container associated with a second detector and a second measurement device;
a plurality of identifiers readable by the first detector and the second detector, each identifier being associated with one of a plurality of animals;
a central station in communication with the at least one food monitoring station;
wherein the at least one food monitoring station is configured to transmit event data to the central station upon an occurrence of at least one of: i) at least one of the identifiers being in range of at least one of the detectors, ii) a change in condition of the first measurement device, and iii) a change in condition of the second measurement device.

2. The palatability monitoring system of claim 1 wherein the event data includes at least one of: i) identification of the at least one identifier proximate at least one of the detectors; ii) identification of the at least one detector proximate at least one of the identifiers; iii) a condition of the first measurement device; iv) a condition of the second measurement device.

3. The palatability monitoring system of claim 1 wherein the at least one food monitoring station includes an interior portion with access to the first food container and the second food container and a barrier configured to substantially restrict access to the interior portion to a single animal.

4. The palatability monitoring system of claim 1 wherein the at least one food monitoring station includes a substantially transparent wall configured to permit visual observation of a feeding event.

5. The palatability monitoring system of claim 1 wherein the feeding station is configured and dimensioned to transmit event data when any of the plurality of animals approaches the first food container and to transmit event data when any of the plurality of animals approaches the second food container.

6. The palatability monitoring system of claim 1, further comprising a camera configured to operate upon the occurrence of an animal entering the feeding station.

7. The palatability monitoring system of claim 1, further comprising a camera configured to operate upon the occurrence of an animal approaching a food container.

8. The palatability monitoring system of claim 1 wherein the identifier includes a tag worn by an animal and the at least one food monitoring station includes a beveled surface associated with the first detector and the second detector, the beveled surface being configured and dimensioned such that the tag rests upon the beveled surface in a position readable by one of the detectors when the animal approaches one of the food containers.

9. The palatability monitoring system of claim 1, wherein the first measurement device is configured to measure the weight of food in the first food container and the second measurement device is configured to measure the weight of food in the second food container.

10. The palatability monitoring system of claim 1 further comprising a database configured to record event data transmitted from the food monitoring stations.

11. A method of collecting preference data from a plurality of group-housed animals comprising:
providing a food monitoring station having at least two food containers that are accessible to one of the animals located in the food monitoring station;
transmitting event data from the food monitoring station to a central station when one of the plurality of animals approaches one of the at least two food containers.

12. The method of claim 11 wherein transmitting event data includes transmitting information associated with the identity of the animal that approaches one of the at least two food containers.

13. The method of claim 11 wherein transmitting event data includes transmitting consumption data associated with a change in condition associated with at least one of the food containers.

14. In a system having a food monitoring station including at least two food containers each of which are accessible to an animal located within the food monitoring station, and each container being associated with a detector device and a measuring device, and the food monitoring station configured to transmit data from the food monitoring station to a central station having a database for storing data, a method for generating palatability data comprising:
transmitting animal identification information and container information from the monitoring station to the database in response to detection of the animal proximate one of the containers; and
transmitting consumption information from the monitoring station to the database in response to a change in condition of the measuring device associated with one of the containers.

15. The method of claim 14 wherein transmitting animal identification information and container information includes transmitting information associated with a container the animal first approached.

16. The method of claim 14 wherein transmitting consumption information includes transmitting information associated with a reduction in food from one of the containers.

17. The method of claim 14 wherein transmitting consumption information includes transmitting information only after a predetermined change in condition of one of the food containers is detected.

18. The method of claim 14 wherein monitoring information is continuously transmitted from the monitoring station to the central station.

19. A food monitoring station for use in a system for collecting palatability data from group-housed animals comprising:
a plurality of walls defining an interior of the food monitoring station;
a plurality of food containers within the interior of the food monitoring station wherein the food containers are equally accessible to at least one of the group-housed animals located within the interior of the food monitoring station;
a barrier configured to substantially restrict access to the interior of the food monitoring station to a single animal;
a detector means for detecting an animal proximate one of the food containers;
a change in condition means for detecting the consumption of food from one of the food containers;
a transmission means for transmitting data from the food monitoring station to a database.

20. The food monitoring station of claim 19 wherein the detecting means for detecting an animal proximate one of the food containers includes radio frequency identification.
